(19) United States
(12) Patent Application Publication
(10) Pub. No.: US 2026/0056409 A1
(43) Pub. Date: Feb. 26, 2026

(54) Optical Module and VR Eyepiece System

(71) Applicant: ZHEJIANG SUNNY OPTICS CO., LTD., Yuyao Ningbo (CN)

(72) Inventors: Biran CHEN, Yuyao Ningbo (CN); Xiaobin ZHANG, Yuyao Ningbo (CN); Lin HUANG, Yuyao Ningbo (CN)

(73) Assignee: ZHEJIANG SUNNY OPTICS CO., LTD., Yuyao Ningbo (CN)

(21) Appl. No.: 18/991,500

(22) Filed: Dec. 21, 2024

(30) Foreign Application Priority Data
Aug. 22, 2024 (CN) 202411156496.1
Oct. 14, 2024 (CN) 202411432685.7

(51) Int. Cl. G02B 27/01; G02B 3/00; G02B 5/30; G02B 27/00

(52) U.S. Cl. CPC G02B 27/0172; G02B 3/0043; G02B 27/0081; G02B 2003/0093; G02B 5/3033; G02B 5/3083; G02B 27/0018; G02B 2027/011; G02B 2027/0123; G02B 2027/0178

(57) ABSTRACT

The disclosure provides an optical module and a VR eyepiece system. The optical module sequentially includes along an optical axis from an eye side to an image side: a cemented lens group, including a pair of plano-convex lenses, a first transflective film located between the pair of plano-convex lenses, a pair of first quarter-wave plates respectively arranged outside of the pair of plano-convex lenses, a pair of first polarizing reflective films respectively arranged outside of the pair of first quarter-wave plates; a refraction and reflection assembly, including a third lens, and a second quarter-wave plate and a second transflective film which are respectively arranged at an eye-side surface and an image-side surface of the third lens. In this way, light achieves multiple reflections within the cemented lens group, which is also able to increase an optical energy utilization of the cemented lens group while achieving folding of an optical path.

### CROSS-REFERENCE TO RELATED APPLICATIONS

The disclosure claims the priority to Chinese Patent Application No. 202411156496.1, filed with the China National Intellectual Property Administration (CNIPA) on Aug. 22, 2024, and Chinese Patent Application No. 202411432685.7, filed with the China National Intellectual Property Administration (CNIPA) on Oct. 14, 2024, which are hereby incorporated by reference in their entireties.

### TECHNICAL FIELD

The disclosure relates to the technical field of VR eyepiece systems, and in particular, to an optical module and a VR eyepiece system.

### BACKGROUND

With continuous development of virtual reality technology, people have higher and higher requirements on imaging effects of VR glasses. In the future, in order to improve the imaging effect of an optical system, a Pancake optical architecture will become the mainstream; and the Pancake architecture reduces the length of the optical system by folding an optical path by arranging a group of refraction and reflection films in a lens assembly. Further, the development of VR devices also needs to take wearing comfort of users into account, which places higher requirements on the size miniaturization and light weight of the VR devices. However, the Pancake architecture itself has an inherent problem of light loss, which is specifically represented by exponential attenuation of the intensity of light in a refraction and reflection process, and this has always been a limitation on the upgrade of the Pancake architecture and the development of the VR devices.

### SUMMARY

On the basis of deficiencies of large length, high light loss during refraction and reflection, and serious problem of ghost image in the VR eyepiece systems in the related art, it is necessary to provide an optical module and a VR eyepiece system.

Some embodiments of the disclosure provide an optical module, sequentially includes along an optical axis from an eye side to an image side:
a cemented lens group, including a pair of plano-convex lenses which are symmetrically arranged and have mutually cemented flat surfaces, a first transflective film located between the pair of plano-convex lenses, a pair of first quarter-wave plates respectively arranged outside of the pair of plano-convex lenses, and a pair of first polarizing reflective films respectively arranged outside of the pair of first quarter-wave plates; and
a refraction and reflection assembly, including a third lens, and a second quarter-wave plate arranged at an eye-side surface of the third lens and a second transflective film arranged at an image-side surface of the third lens.

With this arrangement, linearly polarized light achieves multiple reflections within the cemented lens group. Specifically, for the cemented lens group, the linearly polarized light is incident from the first polarizing reflective film and the first quarter-wave plate which are located on the image side, and is divided into two parts of light in the first transflective film; wherein one part of light is respectively reflected back at the first transflective film and the first polarizing reflective film which is located on the eye side, and then is emitted from the first polarizing reflective film; and the other part of light is reflected back at the first transflective film and the first polarizing reflective film which is located on the image side, and then pass through the first transflective film, the plano-convex lens, the first quarter-wave plate and the first polarizing reflective film in sequence. As the pair of plano-convex lenses are symmetrical with respect to a cementing flat surface, the two parts of light are respectively reflected back at the pair of first polarizing reflective films and then converge at the first transflective film of the cemented lens group, and a final imaging is consistent, which is also able to increase an optical energy utilization of the cemented lens group while achieving folding of an optical path.

In some embodiments, the pair of plano-convex lenses are respectively a first lens away from the third lens and having a negative refractive power and a second lens close to the third lens and having a positive refractive power, and an eye-side surface of the third lens is a concave surface.

With this arrangement, compared with light reaching the image-side surface of the third lens, light passing through the third lens is more divergent, which helps to reduce image edge distortion of the optical module.

In some embodiments, the eye-side surface of the third lens is cemented to an image-side surface of the second lens.

With this arrangement, no air exists between the second lens and the third lens, which is able to avoid ghost images caused by refraction and reflection of light between different propagation media.

In some embodiments, the third lens and the second lens are arranged at an interval, and a second polarizing reflective film is further provided on an eye-side surface of the refraction and reflection assembly.

With this arrangement, a choice of a curvature radius of the eye-side surface of the third lens is not limited by an image-side surface of the second lens, and the second polarizing reflective film, the second quarter-wave plate and the second transflective film form a basis of a Pancake architecture, and achieve refraction and reflection of light; on the other hand, the second polarizing reflective film and the first polarizing reflective film which is located on the image-side surface of the second lens cooperate with each other, and only allow linearly polarized light with a specific phase to pass through, which is able to avoid ghost images caused by multiple refractions and multiple reflections of light between the first lens and the second lens.

In some embodiments, a thickness of each of the pair of first polarizing reflective films and a thickness of the second polarizing reflective film are greater than or equal to 0.1 mm and less than or equal to 0.12 mm; a thickness of each of the pair of first quarter-wave plates and a thickness of the second quarter-wave plate are greater than or equal to 0.1 mm and less than or equal to 0.12 mm; and a thickness of the first transflective film and a thickness of the second transflective film are greater than or equal to 0.1 mm and less than or equal to 0.12 mm.

With this arrangement, during design, by considering a thickness of each film material, a deviation between final production and design of the optical system is reduced, and a correspondence between design indexes and production indexes is increased.

In some embodiments, an included angle between a slow axis of one of the pair of first quarter-wave plates and a polarization axis of one of the pair of first polarizing reflective films which are adjacent is 45°, and an included angle between a slow axis of the second quarter-wave plate and a polarization axis of the second polarizing reflective film which are adjacent is 45°.

With this arrangement, the included angle between the slow axis of the quarter-wave plate and the polarization axis of the polarizing reflective film is controlled, and it is ensured that light is able to be first reflected and then projected when passing through the polarizing reflective film, achieving an effect of folding an optical path, thereby reducing a total length of the optical system, and improving a performance of the optical system.

In some embodiments, a curvature radius R1 of an eye-side surface of the first lens, a curvature radius R4 of an image-side surface of the second lens, and a curvature radius R5 of the eye-side surface of the third lens satisfy:

$$R 1 = R 4 ; and 0.84 < R 4 / R 5 < 6.15 .$$

With this arrangement, by controlling the curvature radii of the first lens and the second lens, such that the first lens and the second lens are symmetrical relative to the transflective film, a consistency of a folded optical path of light in the first lens and the second lens is improved; and by controlling the curvature radius of the image-side surface of the second lens and the curvature radius of the eye-side surface of the third lens, an angle of light when passing through the image-side surface of the second lens is controlled, which is beneficial to improving an imaging performance of an outer field of view.

In some embodiments, a center thickness CT1 of the first lens, a center thickness CT2 of the second lens, and a center thickness CT3 of the third lens satisfy:

$$1.33 < ( CT 1 + CT 2 ) / CT 3 < 4.97 .$$

With this arrangement, by controlling the center thicknesses of the three lenses, thicknesses of the lenses are within reasonable ranges, such that an overall weight of the three lenses is reduced, and the optical module is lighter and thinner.

In some embodiments, an edge thickness ET1 of the first lens, an edge thickness ET2 of the second lens and an edge thickness ET3 of the third lens satisfy:

$$1.28 < ET 3 / ( ET 1 + ET 2 ) < 1.78 .$$

With this arrangement, by controlling the edge thicknesses of the three lenses, it is ensured that subsequently, VR glasses have sufficient bearing surface and volume when manufacturing a structural member, thereby improving a processability of the optical module.

Some other embodiments of the disclosure further provide a VR eyepiece system, including:
the optical module as described above; and
a display screen arranged on an image-side surface of the optical module, wherein the display screen includes a screen body, and a linear polarizer and a third quarter-wave plate which are sequentially arranged on an eye-side surface of the screen body from an image side to an eye side, an included angle between a slow axis of the third quarter-wave plate and a polarization axis of the linear polarizer is 45°.

With this arrangement, the linear polarizer and the third quarter-wave plate are used to convert natural light emitted by the screen body into polarized light capable of entering the optical module and achieving multiple reflections, so as to ensure that light has an effect of folding an optical path in subsequent film materials. By controlling a position where each film material is attached, light emitted from the display screen is able to be reflected back at the first lens, the second lens and the third lens, respectively, an optical path length of light in the lenses is increased, which effectively reduces an overall length of the optical system from an eye-side surface of the first lens to the display screen, such that VR glasses applying the VR eyepiece system are lighter and thinner as a whole, reducing a load of the VR glasses on the neck, nose and other parts of a wearer during use; in addition, a performance of the optical system is improved, and an use experience of the wearer is improved.

In some embodiments, Imgh is a half of a diagonal length of an effective pixel region of the screen body, and an effective focal length f of the optical module, a half field of view HFOV of the optical module and the Imgh satisfy:

$$1.43 < f * tan ( HFOV ) / Imgh < 1.62 .$$

With this arrangement, by controlling a relationship between the effective focal length, the field of view and the image height of the system, the field of view of the optical system is increased, and an immersion feeling of the user is improved.

In some embodiments, a distortion |Dist0.8| of 0.8 field of view of the VR eyepiece system satisfies:

$$16.5 \% < \vert Dist 0.8 \vert < 23.67 \% .$$

With this arrangement, by controlling the distortion of the system, VR glasses using the VR eyepiece system have a better distortion correction effect during subsequent production, thereby improving a final imaging effect.

In some embodiments, an effective focal length f of the optical module and a distance TTL between an eye-side surface of a cemented lens group of the optical module and the display screen on the optical axis satisfy:

$$0.88 < f / TTL < 1.23 .$$

With this arrangement, by controlling a relationship between the effective focal length f of the optical module and the TTL, the total length of the VR eyepiece system is effectively reduced, such that VR glasses using the VR eyepiece system are lighter and thinner.

In some embodiments, a center thickness CT1+CT2 of the cemented lens group of the optical module, a distance T23 from an image-side surface of the cemented lens group of the optical module to an eye-side surface of the third lens of the optical module on the optical axis, and a distance TTL from an eye-side surface of the cemented lens group of the optical module to the display screen on the optical axis satisfy:

$$0.64 < ( CT 1 + CT 2 + T 23 ) / TTL < 0.76 .$$

In this way, by controlling a relationship between the center thickness of the cemented lens group and the TTL, the center thickness of the cemented lens group is within a reasonable range, thereby reducing a production and processing difficulty of the cemented lens group.

In some embodiments, the VR eyepiece system has an entrance pupil diameter EPD, and Imgh is a half of a diagonal length of an effective pixel region of the screen body, and the entrance pupil diameter EPD and the Imgh satisfy:

$$0.20 < EPD / Imgh < 0.35 .$$

With this arrangement, by controlling the entrance pupil diameter, screen brightness and immersion feeling of human eyes when observing are ensured; and by controlling the image height and making full use of the screen, it is ensured that the light emitted from the screen is able to reach the human eyes.

In some embodiments, the VR eyepiece system has an eye position, and a distance ED from the eye position to an eye-side surface of the cemented lens group of the optical module on the optical axis and a distance TTL from an eye-side surface of the cemented lens group of the optical module to the display screen on the optical axis satisfy:

$$0.50 < ED / TTL < 0.74 .$$

With this arrangement, by controlling a relationship between the TTL and the distance ED from the human eyes to the eye-side surface of the cemented lens group on the optical axis, it is ensured that sufficient space is provided for observation by the human eyes, thereby improving the comfort degree of experience.

### BRIEF DESCRIPTION OF THE DRAWINGS

FIG. 1 shows a VR eyepiece system according to Embodiment 1 of the disclosure;

FIG. 2 is a schematic exploded structural view of the VR eyepiece system as shown in FIG. 1;

FIG. 3A shows an astigmatism curve of a visual optical lens according to Embodiment 1 of the disclosure;

FIG. 3B shows a distortion curve of a visual optical lens according to Embodiment 1 of the disclosure;

FIG. 3C shows a longitudinal aberration curve of a visual optical lens according to Embodiment 1 of the disclosure;

FIG. 4 shows a VR eyepiece system according to Embodiment 2 of the disclosure;

FIG. 5 is a schematic exploded structural view of the VR eyepiece system as shown in FIG. 4;

FIG. 6A shows an astigmatism curve of a visual optical lens according to Embodiment 2 of the disclosure;

FIG. 6B shows a distortion curve of a visual optical lens according to Embodiment 2 of the disclosure;

FIG. 6C shows a longitudinal aberration curve of a visual optical lens according to Embodiment 2 of the disclosure;

FIG. 7 shows a VR eyepiece system according to Embodiment 3 of the disclosure;

FIG. 8 is a schematic exploded structural view of the VR eyepiece system as shown in FIG. 7;

FIG. 9A shows an astigmatism curve of a visual optical lens according to Embodiment 3 of the disclosure;

FIG. 9B shows a distortion curve of a visual optical lens according to Embodiment 3 of the disclosure;

FIG. 9C shows a longitudinal aberration curve of a visual optical lens according to Embodiment 3 of the disclosure;

FIG. 10 shows a VR eyepiece system according to Embodiment 4 of the disclosure;

FIG. 11 is a schematic exploded structural view of the VR eyepiece system as shown in FIG. 10;

FIG. 12A shows an astigmatism curve of a visual optical lens according to Embodiment 4 of the disclosure;

FIG. 12B shows a distortion curve of a visual optical lens according to Embodiment 4 of the disclosure; and

FIG. 12C shows a longitudinal aberration curve of a visual optical lens according to Embodiment 4 of the disclosure.

### REFERENCE SIGNS

10. Cemented lens group; 101. Plano-convex lens; 11. First lens; 12. Second lens; 13. First transflective film; 14. First polarizing reflective film; 15. First quarter-wave plate; 20. Reflection assembly; 21. Third lens; 22. Second quarter-wave plate; 23. Second transflective film; 24. Second polarizing reflective film; 30. Display screen; 31. Screen body; 32. Linear polarizer; 33. Third quarter-wave plate.

### DETAILED DESCRIPTION OF EMBODIMENTS

The disclosure will be further described in detail below in combination with the drawings and embodiments. It can be understood that the specific embodiments described herein are merely configured for explaining the disclosure, rather than limiting the disclosure. In addition, it should be noted that, for ease of description, only some, but not all, of structures related to the disclosure are shown in the drawings.

To make the objects, features and advantages above of the disclosure clearer and readily understood, hereinafter, specific embodiments of the disclosure will be described in detail in combination with the accompanying drawings. In the following description, numerous specific details are set forth in order to provide a thorough understanding of some embodiments of the disclosure. However, some embodiments of the disclosure can be implemented in many other manners different from those described herein, and a person skilled in the art could make similar improvements without departing from the concept of some embodiments of the disclosure, and therefore, some embodiments of the disclosure are not limited to the specific embodiments disclosed below.

In the illustration of some embodiments of the disclosure, it should be understood that orientation or positional relationships indicated by terms such as “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential” etc. are orientation or positional relationships based on the accompanying drawings, are only used to facilitate the illustration of some embodiments of the disclosure and to simplify the illustration, rather than indicating or implying that an apparatus or element referred to must have a specific orientation, and be constructed and operated in the specific orientation, and therefore said terms cannot be understood as limitation to some embodiments of the disclosure.

In addition, terms “first” and “second” are only used for descriptive purposes, and cannot be understood as indicating or implying relative importance or implicitly indicating the number of indicated technical features. Thus, features defined by “first” and “second” may explicitly or implicitly include at least one of the features. In the illustration of some embodiments of the disclosure, the meaning of “a plurality of” is at least two, for example, two, three, etc., unless explicitly and specifically defined otherwise.

In some embodiments of the disclosure, unless specified or limited otherwise, the terms such as “mount”, “connect to”, “connecting” and “fix”, etc. should be understood broadly, and for example, may be fixed connection, and may also be detachable connection, or integral connection; may be mechanical connection, and may also be electrical connection; and may be direct connection, and may also be indirect connection by means of an intermediate medium, and may also be interior communication between two elements, or interaction relationship between two elements, unless clearly defined otherwise. For a person of ordinary skill in the art, specific meanings of the described terms in some embodiments of the disclosure could be understood according to specific situations.

In some embodiments of the disclosure, unless specified or limited otherwise, a first feature being “above” or “below” a second feature may be the first feature being in direct contact with the second feature, or the first feature being in indirect contact with the second feature via an intermediate medium. Furthermore, a first feature being “over”, “above”, or “on” a second feature may be the first feature being directly above or obliquely above the second feature, or merely mean that the first feature having a horizontal height higher than that of the second feature. The first feature being “below”, “beneath” or “under” the second feature may be the first feature being directly below or obliquely below the second feature, or merely mean that the first feature having a horizontal height lower than that of the second feature.

It should be noted that when an element is referred to as being “fixed to” or “provided on” another element, the element may be directly on the other element or an intermediate element may also exist. When an element is considered as being “connected” to another element, the element may be directly connected to the other element or an intermediate element may exist at the same time. The terms “perpendicular”, “horizontal”, “upper”, “lower”, “left”, “right” and similar expressions as used herein are for illustrative purposes only, and are not meant to be the only embodiments.

With continuous development of virtual reality technology, people have higher and higher requirements on imaging effects of VR glasses. In the future, in order to improve the imaging effect of an optical system, a Pancake optical architecture will become the mainstream; and the Pancake architecture reduces a length of the optical system by folding an optical path by arranging a group of refraction and reflection films in a lens assembly. Further, the development of VR devices also needs to take wearing comfort of users into account, which places higher requirements on a size miniaturization and light weight of the VR devices. However, the Pancake architecture itself has an inherent problem of light loss, which is specifically represented by exponential attenuation of an intensity of light in a refraction and reflection process, and this has always been a limitation on an upgrade of the Pancake architecture and the development of the VR devices.

On this basis, it is necessary to provide an optical module and a VR eyepiece system capable of increasing an optical energy utilization while reducing the length of the optical system.

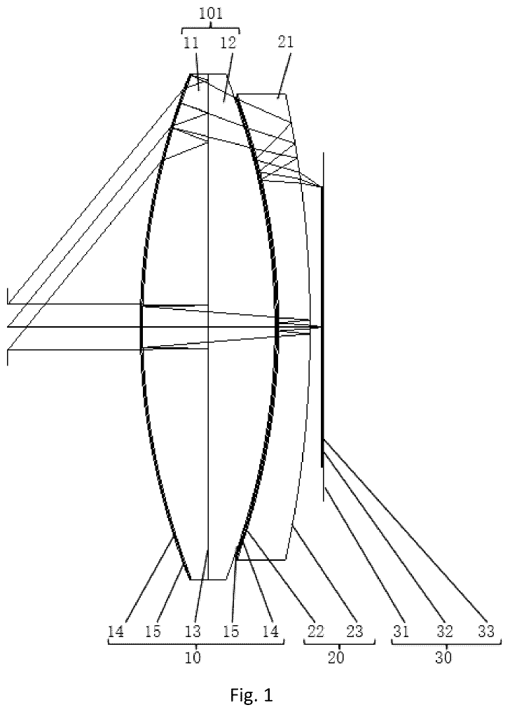

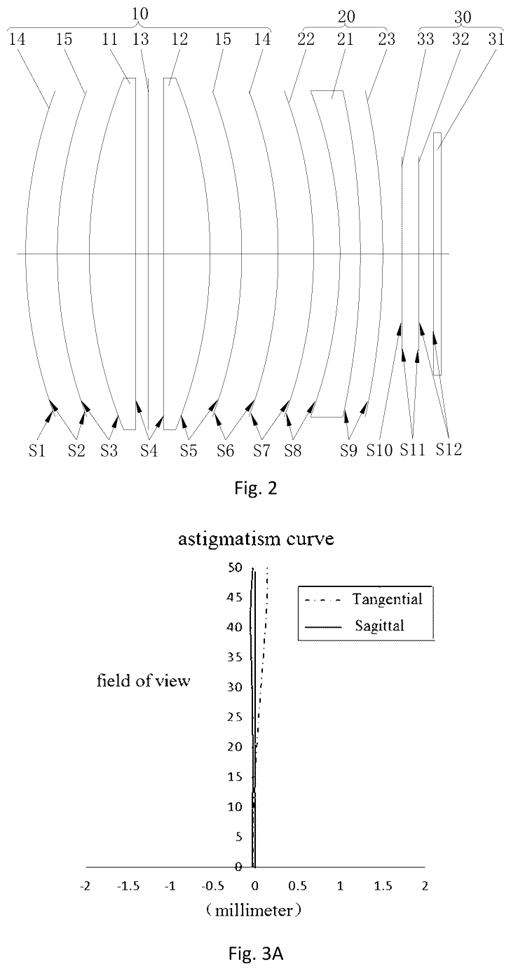

Referring to FIGS. 1-2, FIG. 1 shows a VR eyepiece system according to Embodiment 1 of the disclosure; and FIG. 2 is a schematic exploded structural view of the VR eyepiece system as shown in FIG. 1. The VR eyepiece system includes an optical module and a display screen 30, wherein the optical module includes a cemented lens group 10 and a refraction and reflection assembly 20 in sequence from an eye side to an image side along an optical axis. Specifically, the cemented lens group 10 includes a pair of plano-convex lenses 101 which are symmetrically arranged and have mutually cemented flat surfaces, a first transflective film 13 located between the pair of plano-convex lenses 101, a pair of first quarter-wave plates 15 respectively arranged outside of the pair of plano-convex lenses 101, and a pair of first polarizing reflective films 14 respectively arranged outside of the pair of first quarter-wave plates 15; wherein the pair of plano-convex lenses 101 are respectively a first lens 11 away from a third lens 21 and having a negative refractive power and a second lens 12 close to the third lens 21 and having a positive refractive power; the refraction and reflection assembly 20 includes the third lens 21, and a second quarter-wave plate 22 and a second transflective film 23 which are respectively arranged at an eye-side surface and an image-side surface of the third lens 21; the display screen 30 includes a screen body 31, and a linear polarizer 32 and a third quarter-wave plate 33 which are sequentially arranged on an eye-side surface of the screen body 31 from the image side to the eye side, wherein an included angle between a slow axis of the third quarter-wave plate 33 and a polarization axis of the linear polarizer 32 is 45°; and an included angle between a slow axis of one of the pair of first quarter-wave plates 15 and a polarization axis of one of the pair of first polarizing reflective films 14 which are adjacent is 45°, and an included angle between a slow axis of the second quarter-wave plate 22 and a polarization axis of the second polarizing reflective film 24 which are adjacent is 45°.

The specific optical path is as follows: light emitted from the display screen 30 is converted into right-handed circularly polarized light after passing through the linear polarizer 32 and the third quarter-wave plate 33 attached to the screen body 31, and the light enters the optical module in a state of the right-handed circularly polarized light and is able to achieve multiple reflections in the three lenses, and finally is emitted from an eye-side surface of the optical module to reach human eyes. It should be noted that in the cemented module, for the cemented lens group 10, the linearly polarized light is incident from the first polarizing reflective film 14 and the first quarter-wave plate 15 which are located on an image-side of the second lens 12, and is divided into two parts of light at the first transflective film 13; wherein one part of light is reflected back once at the first transflective film 13 and the first polarizing reflective film 14 which is located on the eye side, respectively, and then is emitted from the first polarizing reflective film 14; and the other part of light is reflected back once at the first transflective film 13 and the first polarizing reflective film 14 which is located on the image side, and then pass through the first transflective film 13, the plano-convex lens 101, the first quarter-wave plate 15 and the first polarizing reflective film 14 in sequence. As the pair of plano-convex lenses 101 are symmetrical with respect to a cementing flat surface, the two parts of light are respectively reflected back at the pair of first polarizing reflective films 14 and then converge at the first transflective film 13 of the cemented lens group 10, and a final imaging is consistent, which is also able to increase an optical energy utilization of the cemented lens group 10 while achieving folding of an optical path.

The optical module and VR eyepiece system provided in some embodiments of the disclosure have at least four advantages:

First, as shown in the structural schematic view of the optical path of the VR eyepiece system, by controlling the first lens 11 and the second lens 12 to be completely symmetrical with respect to the cementing surface, after the light converges after being reflected back in the first lens 11 and the second lens 12, the final imaging is consistent, thereby increasing the optical energy utilization of this part.

Secondly, the pair of plano-convex lenses 101, i.e. the first lens 11 and the second lens 12, have the same shape and use the same light-transmitting material, and the two lenses is able to be manufactured by using the same mold, thereby facilitating reduction of the production cost.

Moreover, by controlling positions and angles of the linear polarizer 32 and the quarter-wave plate attached to the display screen 30, light is converted into circularly polarized light when passing through the linear polarizer and the quarter-wave plate, so as to ensure that the light has an effect of folding an optical path in subsequent film materials, which is beneficial to reducing a total length of the VR eyepiece system and improving a performance of the VR eyepiece system.

Finally, by controlling a position where each film material is attached, light emitted from the display screen 30 is able to be reflected back in the first lens 11 and the third lens 21, respectively, an optical path length of the light in the lenses is increased, which effectively reduces an overall length of an optical system from an eye-side surface of the first lens 11 to the display screen 30, such that VR glasses applying the VR eyepiece system are lighter and thinner as a whole, reducing a load of the VR glasses on the neck, nose and other parts of a wearer during use; in addition, a performance of the optical system is improved, and a use experience of the wearer is improved.

In an embodiment provided in the disclosure, the eye-side surface of the third lens 21 is a concave surface. In this way, compared with light reaching the image-side surface of the third lens 21, light passing through the third lens 21 is more divergent, which facilitates arrangement of the display screen 30 with a larger size, and a screen resolution required by the same picture quality is lower, which facilitates reduction of a production cost. In other words, under the same screen resolution condition, an image quality is higher, which is beneficial to improving the image quality, and also improving an immersive experience of a user. Intuitively speaking, a range of a viewing angle of human eyes is limited, and due to a divergent effect of the eye-side surface of the third lens 21 on the light, the human eyes are able to receive other pictures beyond the viewing angle, and a price is that a content in the picture is compressed towards the center; at this time, synchronously increasing the size of the display screen 30 is able to increase a picture occupation rate of the display screen 30 within the range of the viewing angle of the human eyes, thereby achieving the described technical effects.

In an embodiment provided in the disclosure, the eye-side surface of the third lens 21 is cemented to an image-side surface of the second lens 12, and no air exists between the second lens 12 and the third lens 21, which is able to avoid ghost images caused by refraction and reflection of light between different propagation media.

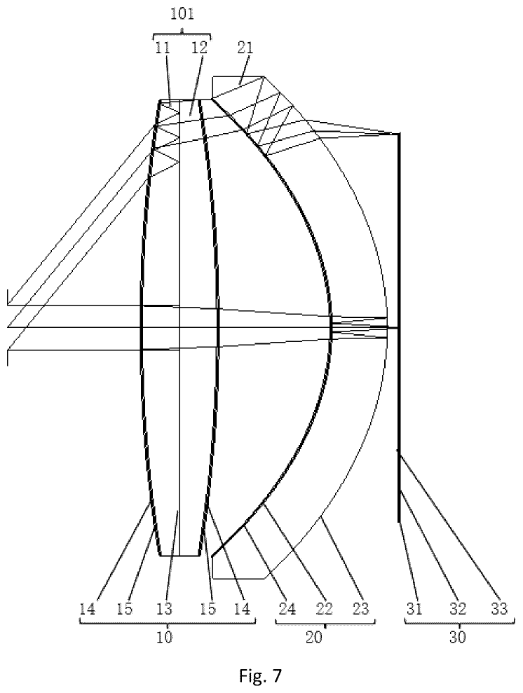

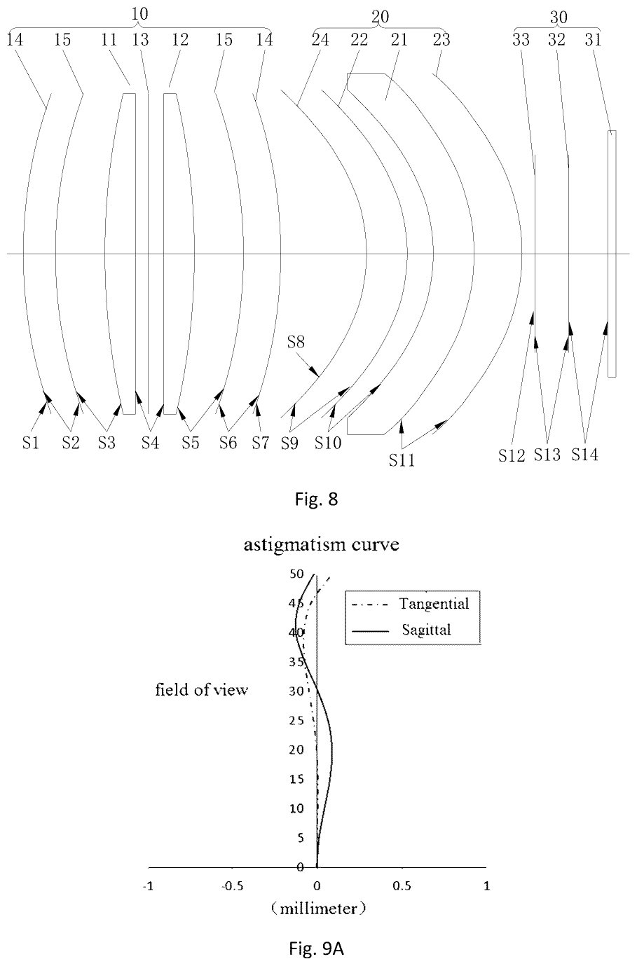

Referring to FIGS. 7-8, FIG. 7 shows a VR eyepiece system according to Embodiment 2 of the disclosure; and FIG. 8 is a schematic exploded structural view of the VR eyepiece system as shown in FIG. 7. In another embodiment provided in the disclosure, the third lens 21 and the second lens 12 are arranged at an interval, and a second polarizing reflective film 24 is further provided on an eye-side surface of the refraction and reflection assembly. A choice of a curvature radius of the eye-side surface of the third lens 21 is not limited by the image-side surface of the second lens 12, and the second polarizing reflective film 24, the second quarter-wave plate 22 and the second transflective film 23 form a basis of a Pancake architecture, and achieve refraction and reflection of light. On the other hand, the second polarizing reflective film 24 and the first polarizing reflective film 14 which is located on the image-side surface of the second lens 12 cooperate with each other, and only allow linearly polarized light with a specific phase to pass through, which is able to avoid ghost images caused by multiple refractions and multiple reflections of light between the first lens 11 and the second lens 12.

In an embodiment, a thickness of each of the pair of first polarizing reflective films 14 and a thickness of the second polarizing reflective film 24 are greater than or equal to 0.1 mm and less than or equal to 0.12 mm; a thickness of each of the pair of first quarter-wave plates 15 and a thickness of the second quarter-wave plate 22 are greater than or equal to 0.1 mm and less than or equal to 0.12 mm; and a thickness of the first transflective film 13 and a thickness of the second transflective film 23 are greater than or equal to 0.1 mm and less than or equal to 0.12 mm. During design, by considering a thickness of each film material, a deviation between final production and design of the optical system is reduced, and a correspondence between design indexes and production indexes is increased.

In an embodiment, a curvature radius R1 of an eye-side surface of the first lens 11, a curvature radius R4 of the image-side surface of the second lens 12, and a curvature radius R5 of the eye-side surface of the third lens 21 satisfy:

$$R 1 = R 4 ; and 0.84 < R 4 / R 5 < 6.15 .$$

In the conditional expression, by controlling the curvature radii of the first lens 11 and the second lens 12, such that the first lens and the second lens are symmetrical relative to the transflective film, a consistency of a folded optical path of light in the first lens 11 and the second lens 12 is improved; and by controlling the curvature radius of the image-side surface of the second lens 12 and the curvature radius of the eye-side surface of the third lens 21, an angle of light when passing through the image-side surface of the second lens 12 is controlled, which is beneficial to improving an imaging performance of an outer field of view.

More specifically, 0.86≤R4/R5≤6.13.

In an embodiment, a center thickness CT1 of the first lens 11, a center thickness CT2 of the second lens 12, and a center thickness CT3 of the third lens 21 satisfy:

$$1.33 < ( CT 1 + CT 2 ) / CT 3 < 4.97 .$$

In the conditional expression, by controlling the center thicknesses of the three lenses, thicknesses of the lenses are within reasonable ranges, such that an overall weight of the three lenses is reduced, and the optical module is lighter and thinner.

More specifically, 1.35≤(CT1+CT2)/CT3≤4.95.

In an embodiment, an edge thickness ET1 of the first lens 11, an edge thickness ET2 of the second lens 12 and an edge thickness ET3 of the third lens 21 satisfy:

$$1.28 < ET 3 / ( ET 1 + ET 2 ) < 1.78 .$$

In the conditional expression, by controlling the edge thicknesses of the three lenses, it is ensured that subsequently, VR glasses have sufficient bearing surface and volume when manufacturing a structural member, thereby improving a processability of the optical module.

More specifically, 1.3≤ET3/(ET1+ET2)≤1.76.

In an embodiment, Imgh is a half of a diagonal length of an effective pixel region of the screen body 31, and an effective focal length f of the optical module, a half field of view HFOV of the optical module, and the Imgh satisfy:

$$1.43 < f * tan ( HFOV ) / Imgh < 1.62 .$$

In the conditional expression, by controlling a relationship between the effective focal length, the field of view and the image height of the system, the field of view of the optical system is increased, and an immersion feeling of the user is improved.

More specifically, 1.45≤f*tan (HFOV)/Imgh≤1.60.

In an embodiment, a distortion |Dist0.8| of 0.8 field of view of the VR eyepiece system satisfies:

$$16.5 \% < \vert Dist 0.8 \vert < 23.67 \% .$$

In the conditional expression, by controlling the distortion of the system, VR glasses using the VR eyepiece system have a better distortion correction effect during subsequent production, thereby improving a final imaging effect.

More specifically, 16.90%≤|Dist0.8|≤23.65%.

In an embodiment, the effective focal length f of the optical module and a distance TTL between an eye-side surface of a first lens 11 of the optical module and the display screen 30 on the optical axis satisfy:

$$0.88 < f / TTL < 1.23 .$$

In the conditional expression, by controlling a relationship between the effective focal length f of the optical module and the TTL, the total length of the VR eyepiece system is effectively reduced, such that VR glasses using the VR eyepiece system are lighter and thinner.

More specifically, 0.90≤f/TTL≤1.21.

In an embodiment, the center thickness CT1 of the first lens 11 of the optical module, the center thickness CT2 of the second lens 12, a distance T23 from the image-side surface of the second lens 12 of the optical module to an eye-side surface of a third lens 21 of the optical module on the optical axis, and the distance TTL from the eye-side surface of the cemented lens group 10 of the optical module to the display screen 30 on the optical axis satisfy:

$$0.64 < ( CT 1 + CT 2 + T 23 ) / TTL < 0.76 .$$

In the conditional expression, by controlling a relationship between the center thickness CT1 of the first lens 11, the center thickness CT2 of the second lens 12, the distance T23 from the image-side surface of the second lens 12 of the optical module to an eye-side surface of a third lens 21 of the optical module on the optical axis and the TTL, the center thickness of the cemented lens group 10 is within a reasonable range, thereby reducing a production and processing difficulty of the cemented lens group 10.

More specifically, 0.66≤(CT1+CT2+T23)/TTL≤0.74.

In an embodiment, the VR eyepiece system has an entrance pupil diameter EPD, and the entrance pupil diameter EPD and the Imgh satisfy:

$$0.2 < EPD / Imgh < 0.35 .$$

In the conditional expression, by controlling the entrance pupil diameter EPD, screen brightness and immersion feeling of human eyes when observing are ensured; and by controlling the image height and making full use of the display screen 30, it is ensured that the light emitted from the screen is able to reach the human eyes.

More specifically, 0.21≤EPD/Imgh≤0.33.

In an embodiment, the VR eyepiece system has an eye position, and a distance ED from the eye position to an eye-side surface of the cemented lens group 10 of the optical module on the optical axis and the distance TTL from the eye-side surface of the first lens 11 of the optical module on the optical axis to the display screen 30 satisfy:

$$0.5 < ED / TL < 0.74 .$$

In the conditional expression, by controlling a relationship between the TTL and the distance ED from the human eyes to the eye-side surface of the first lens 11 on the optical axis, it is ensured that sufficient space is provided for observation by the human eyes, thereby improving the comfort degree of experience.

More specifically, 0.51≤ED/TTL≤0.72.

Hereinafter, some specific but non-limiting embodiments of the disclosure are described in more detail with reference to the accompanying drawings. It should be understood that any one of the following Embodiments 1 to 4 is applicable to all embodiments of the disclosure.

For ease of illustration, in the following embodiments, STO denotes a surface of a diaphragm, IMG denotes an image surface of a VR eyepiece system, f denotes the effective focal length of the VR eyepiece system, Imgh denotes the half of the diagonal length Imgh of the effective pixel region of the screen body of the VR eyepiece system, and EPD denotes the entrance pupil diameter of the VR eyepiece system; f denotes an overall focal length of the optical module; and fi denotes the effective focal length of an ith lens, i=1, 2, 3.

In addition, the numbers of functional surfaces where light rays pass through in a direction opposite to an optical path are sequentially defined as S1 to SN, wherein S1 indicates a number of a first functional surface where light passes through in a direction opposite to the optical path, and SN indicates a number of an Nth functional surface where light passes through in the direction opposite to the optical path. In the disclosure, the high-order coefficient of each surface is zero, and thus there is no high-order coefficient table, and quadric surface and Aspheric surface still satisfy the following formula:

$$x = \frac{{ch}^{2}}{1 + \sqrt{1 - ( k + 1 ) {c}^{2} {h}^{2}}}$$

In the formula, x denotes sag of a surface parallel to the optical axis, c denotes a curvature, h denotes a radial distance from the optical axis, and k denotes a quadric surface constant.

Embodiment 1 and Embodiment 2 represent two different embodiments in which the second lens 12 and the third lens 21 are in an attached state, respectively. In both embodiments, surfaces corresponding to surface numbers are explained as follows:

S1 is an eye-side surface of the first polarizing reflective film 14 located on the eye side of the first lens 11, S2 is an attachment surface between the first quarter-wave plate 15 and the first polarizing reflective film 14 which are located on the eye side of the first lens 11, S3 is an attachment surface between the first quarter-wave plate 15 located on the eye side of the first lens 11 and the first lens 11, S4 is an attachment surface between the first lens 11 and the second lens 12, S5 is an attachment surface between the second lens 12 and the first quarter-wave plate 15, S6 is an attachment surface between the first quarter-wave plate 15 and the first polarizing reflective film 14 which are located on the image side of the second lens 12, S7 is an attachment surface between the first polarizing reflective film 14 and the second quarter-wave plate 22 which are located on the image side of the second lens 12, S8 is an attachment surface between the third lens 21 and the second quarter-wave plate 22, S9 is an attachment surface between the third lens 21 and the second transflective film 23, S10 is an eye-side surface of the third quarter-wave plate 33, S11 is an attachment surface between the third quarter-wave plate 33 and the linear polarizer 32, and S12 is an attachment surface between the screen body 31 and the linear polarizer 32.

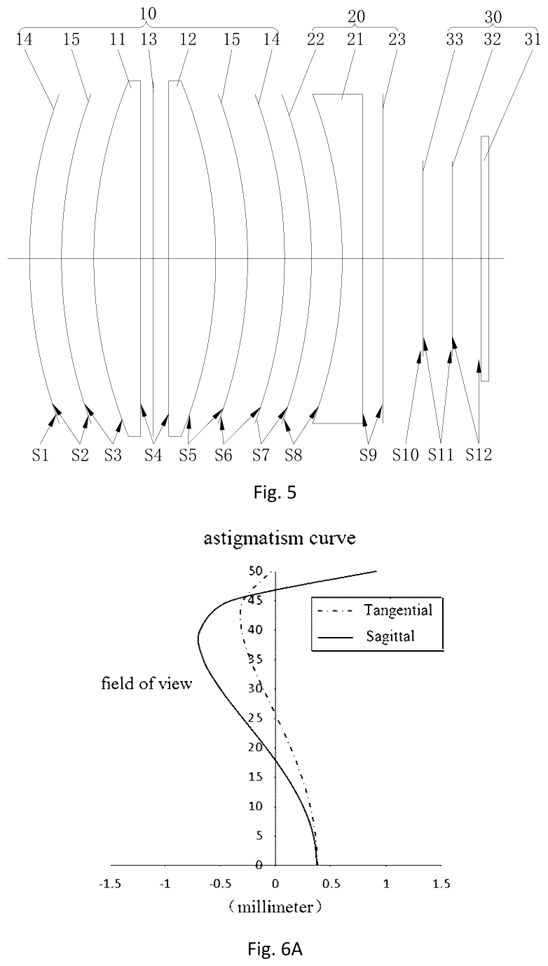

Referring to FIG. 2 or FIG. 5, the optical path and surface numbers are correspondingly explained as follows: regarding the optical path, reflection occurs on four surfaces, i.e. S2, S4, S7 and S9, and refraction occurs on eight surfaces, i.e. S1, S3, S5, S6, S8, S10, S11 and S12. Specifically, light emitted from the screen body 31 passes through S12, S11, S10, S9, and S8 in sequence and is reflected by the first polarizing reflective film located at S7 when reaching S7, then passes through S8 and is reflected by the second transflective film 23 located at S9 when reaching S9, and the light reflected by the second transflective film 23 passes through S8, S7 and S6 in sequence and is divided into two parts by the first transflective film 13 located at S4 when reaching S4. A first part of light is the light refracted by the first transflective film 13, and the refracted light passes through S3 and is reflected by the first polarizing reflective film 14 located at S2 when reaching S2, the light reflected by the first polarizing reflective film 14 passes through S3 in sequence and is reflected by the first transflective film 13 located at S4 when reaching S4, and the light reflected by the first transflective film 13 passes through S3 and S2 sequentially and finally is emitted from S1 to reach human eyes. A second part of light is the light reflected by the first transflective film 13, the reflected light passes through S5 and is reflected by the first polarizing reflective film 14 located at S6 when reaching S6, and the light reflected by the first polarizing reflective film 14 passes through S4, S3 and S2 in sequence and finally is emitted from S1 to reach human eyes.

### Embodiment 1

As shown in FIGS. 1-3C, a VR eyepiece system according to Embodiment 1 is described, in the VR eyepiece system, the third lens 21 is attached to the second lens 12. Table 1 shows design data for the VR eyepiece system of Embodiment 1 in accordance with the conditional expressions above.

TABLE 1
Table of basic optical parameters of the VR eyepiece system of Embodiment 1

| | | | | | | | | | | | | Quadric |
|---|---|---|---|---|---|---|---|---|---|---|---|---|
| | Surface | Surface | | Curvature | | | | | | Refraction | Effective | surface |
| | number | type | | radius | | Thickness | | Materials | | mode | radius | constant K |
| STO | | Spherical | | Infinity | | 12.0000 | | | | Refraction | 2 | |
| | S1 | Quadric | RP | 55.4305 | | 0.1100 | | 1.49 | 57.5 | Refraction | 21.0056 | −1.08E+00 |
| | S2 | Quadric | QWP | 55.4305 | | 0.1100 | | 1.49 | 57.5 | Refraction | 21.0477 | −1.08E+00 |
| REFL1 | S3 | Aspheric | R1 | 55.4305 | CT1 | 6.0001 | N1 | 1.55 | 56.14 | Refraction | 21.0898 | −1.08E+00 |
| | | | | | | | V1 | | | | | |
| | S4 | Spherical | R2 | Infinity | | −6.0001 | | | | Refraction | 21.6979 | |
| | S3 | Quadric | R1 | 55.4305 | | −0.1100 | | 1.49 | 57.5 | Refraction | 21.0898 | −1.08E+00 |
| | S2 | Quadric | QWP | 55.4305 | | 0.1100 | | 1.49 | 57.5 | Refraction | 21.0477 | −1.08E+00 |
| | S3 | Aspheric | R1 | 55.4305 | | 6.0001 | | | | Refraction | 21.0898 | −1.08E+00 |
| REFL2 | S4 | Spherical | R2 | Infinity | CT2 | 6.0001 | N2 | 1.55 | 56.14 | Refraction | 21.6979 | |
| | | | | | | | V2 | | | | | |
| | S5 | Quadric | R4 | −55.4305 | | 0.1100 | | 1.49 | 57.5 | Refraction | 20.2129 | −1.08E+00 |
| | S6 | Quadric | RP | −55.4305 | | 0.1100 | | 1.49 | 57.5 | Refraction | 20.138 | −1.08E+00 |
| | S7 | Quadric | QWP | −55.4305 | | 0.1100 | | 1.49 | 57.5 | Refraction | 20.0631 | −1.08E+00 |
| REFL3 | S8 | Aspheric | R5 | −55.4305 | CT3 | 2.8826 | N3 | 1.64 | 23.98 | Refraction | 19.9883 | −1.08E+00 |
| | | | | | | | V3 | | | | | |
| | S9 | Aspheric | R6 | −95.617 | | −2.8826 | | | | Refraction | 17.9587 | 9.83E+01 |
| | S8 | Quadric | R5 | −55.4305 | | −0.1100 | | 1.49 | 57.5 | Refraction | 19.9883 | −1.08E+00 |
| | S7 | Quadric | QWP | −55.4305 | | 0.1100 | | 1.49 | 57.5 | Refraction | 20.0631 | −1.08E+00 |
| REFL3 | S8 | Aspheric | R5 | −55.4305 | CT3 | 2.8826 | N3 | 1.64 | 23.98 | Refraction | 19.9883 | −1.08E+00 |
| | | | | | | | V3 | | | | | |
| | S9 | Aspheric | R6 | −95.617 | | 1.0000 | | | | Refraction | 17.9587 | 9.83E+01 |
| | S10 | Spherical | QWP | | | 0.1100 | | 1.49 | 57.5 | Refraction | 12.3079 | |
| | S11 | Spherical | LP | | | 0.1100 | | 1.49 | 57.5 | Refraction | 12.2646 | |

It is to be noted that, in the table above, STO indicates a diaphragm, REFL1 indicates the first lens 11, RELF2 indicates the second lens 12, RELF3 indicates the third lens 21, RP indicates a polarizing reflective film, QWP indicates a quarter-wave plate, and BS indicates a transflective film. In addition, in the VR eyepiece system shown in Embodiment 1, TTL=16.65 mm, ED=12.00 mm, Imgh=12.22 mm, HFOV=50.00°, FNO=4.10 mm, f=16.43 mm, f1=−1626.41 mm, f2=1570.98 mm, f3=−51.61 mm, E1=1.58 mm, E2=1.58 mm, and E3=4.36 mm.

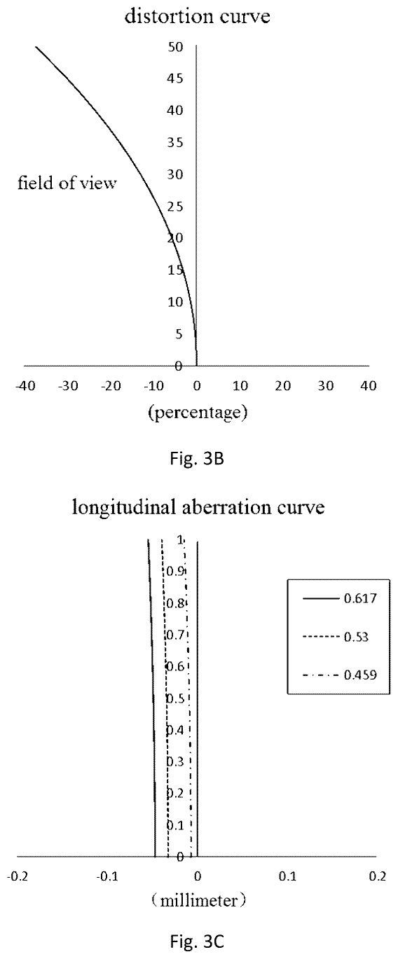

Upon simulation test, it is obtained that an astigmatism curve of the VR eyepiece system of Embodiment 1 is as shown in FIG. 3A, a distortion curve of the VR eyepiece system of Embodiment 1 is as shown in FIG. 3B, and a longitudinal aberration curve of the VR eyepiece system of Embodiment 1 is as shown in FIG. 3C. From FIGS. 3A-3C, it is determined that the VR eyepiece system of Embodiment 1 is able to achieve good imaging quality.

### Embodiment 2

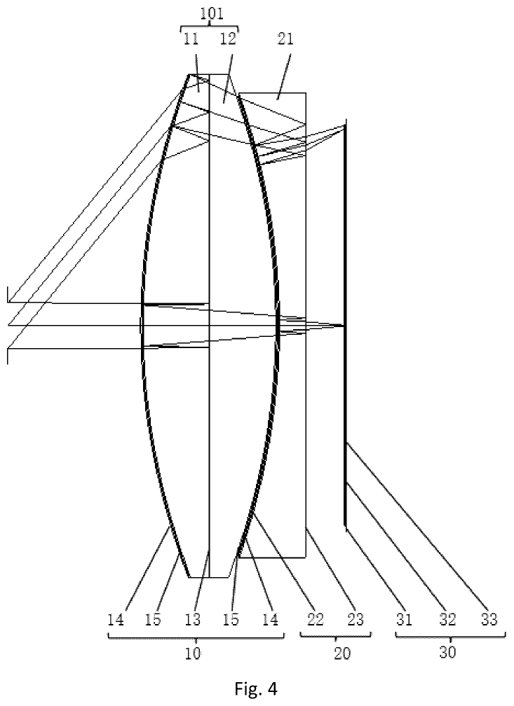

As shown in FIGS. 4-6C, a VR eyepiece system of Embodiment 2 is described, in the VR eyepiece system, the third lens 21 is attached to the second lens 12, and the image-side surface of the third lens 21 is a flat surface. Table 2 shows design data for the VR eyepiece system of Embodiment 2 in accordance with the conditional expressions above.

TABLE 2
Table of basic optical parameters of the VR eyepiece system of Embodiment 2

| | | | | | | | | | | | | Quadric |
|---|---|---|---|---|---|---|---|---|---|---|---|---|
| | Surface | Surface | | Curvature | | | | | | Refraction | Effective | surface |
| | number | type | | radius | | Thickness | | Materials | | mode | radius | constant K |
| STO | | Spherical | | Infinity | | 12.0000 | | | | Refraction | 2 | |
| | S1 | Quadric | RP | 56.6316 | | 0.1100 | | 1.49 | 57.5 | Refraction | 20.7856 | −1.25E+00 |
| | S2 | Quadric | QWP | 56.6316 | | 0.1100 | | 1.49 | 57.5 | Refraction | 20.8290 | −1.25E+00 |
| REFL1 | S3 | Aspheric | R1 | 56.6316 | CT1 | 6.0025 | N1 | 1.55 | 56.14 | Refraction | 20.8724 | −1.25E+00 |
| | | | | | | | V1 | | | | | |
| | S4 | Spherical | R2 | Infinity | | −6.0025 | | | | Reflection | 21.5614 | |
| | S3 | Quadric | R1 | 56.6316 | | −0.1100 | | 1.49 | 57.5 | Refraction | 20.8724 | −1.25E+00 |
| | S2 | Quadric | QWP | 56.6316 | | 0.1100 | | 1.49 | 57.5 | Reflection | 20.8290 | −1.25E+00 |
| | S3 | Aspheric | R1 | 56.6316 | | 6.0025 | | | | Refraction | 20.8724 | −1.25E+00 |
| REFL2 | S4 | Spherical | R2 | Infinity | CT2 | 6.0025 | N2 | 1.55 | 56.14 | Refraction | 21.5614 | |
| | | | | | | | V2 | | | | | |
| | S5 | Quadric | R4 | −56.6316 | | 0.1100 | | 1.49 | 57.5 | Refraction | 20.1967 | −1.25E+00 |
| | S6 | Quadric | RP | −56.6316 | | 0.1100 | | 1.49 | 57.5 | Refraction | 20.1303 | −1.25E+00 |
| | S7 | Quadric | QWP | −56.6316 | | 0.1100 | | 1.49 | 57.5 | Refraction | 20.0640 | −1.25E+00 |
| REFL3 | S8 | Aspheric | R5 | −56.6316 | CT3 | 2.4238 | N3 | 1.64 | 23.98 | Refraction | 19.9977 | −1.25E+00 |
| | | | | | | | V3 | | | | | |
| | S9 | Aspheric | R6 | Infinity | | −2.4238 | | | | Reflection | 17.6770 | −9.90E+01 |
| | S8 | Quadric | R5 | −56.6316 | | −0.1100 | | 1.49 | 57.5 | Refraction | 19.9977 | −1.25E+00 |
| | S7 | Quadric | QWP | −56.6316 | | 0.1100 | | 1.49 | 57.5 | Reflection | 20.0640 | −1.25E+00 |
| REFL3 | S8 | Aspheric | R5 | −56.6316 | CT3 | 2.4238 | N3 | 1.64 | 23.98 | Refraction | 19.9977 | −1.25E+00 |
| | | | | | | | V3 | | | | | |
| | S9 | Aspheric | R6 | Infinity | | 3.4030 | | | | Refraction | 17.6770 | −9.90E+01 |
| | S10 | Spherical | QWP | | | 0.1100 | | 1.49 | 57.5 | Refraction | 17.5853 | |
| | S11 | Spherical | LP | | | 0.1100 | | 1.49 | 57.5 | Refraction | 17.6057 | |
| IMG | S12 | Spherical | | | | 0 | | | | Refraction | 17.6261 | |

It is to be noted that, in the table above, STO indicates a diaphragm, REFL1 indicates the first lens 11, RELF2 indicates the second lens 12, RELF3 indicates the third lens 21, RP indicates a polarizing reflective film, QWP indicates a quarter-wave plate, and BS indicates a transflective film. In addition, in the VR eyepiece system shown in Embodiment 2, TTL=18.60 mm, ED=12.00 mm, Imgh=17.33 mm, HFOV=50.00°, FNO=5.56 mm, f=22.58 mm, f1=−1661.65 mm, f2=1605.02 mm, f3=623.67 mm, E1=1.72 mm, E2=1.72 mm, and E3=6.07 mm.

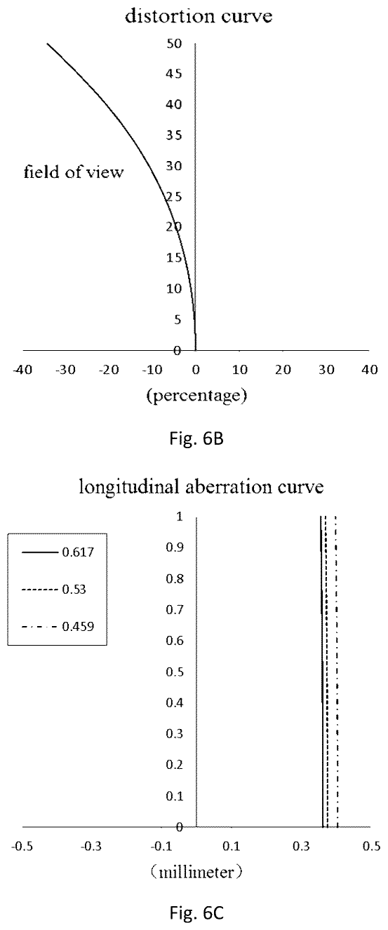

Upon simulation test, it is obtained that an astigmatism curve of the VR eyepiece system of Embodiment 2 is as shown in FIG. 6A, a distortion curve of the VR eyepiece system of Embodiment 2 is as shown in FIG. 6B, and a longitudinal aberration curve of the VR eyepiece system of Embodiment 2 is as shown in FIG. 6C. From FIG. 6A to FIG. 6C, it is determined that the VR eyepiece system of Embodiment 2 is able to achieve good imaging quality.

Embodiment 3 and Embodiment 4 represent two different embodiments in a state in which the second lens 12 and the third lens 21 are arranged at an interval, respectively. In both embodiments, surfaces corresponding to surface numbers are explained as follows:

S1 is an eye-side surface of the first polarizing reflective film 14 located on the eye side of the first lens 11, S2 is an attachment surface between the first quarter-wave plate 15 and the first polarizing reflective film 14 which are located on the eye side of the first lens 11, S3 is an attachment surface between the first quarter-wave plate 15 located on the eye side of the first lens 11 and the first lens 11, S4 is an attachment surface between the first lens 11 and the first transflective film 13, S5 is an attachment surface between the second lens 12 and the first quarter-wave plate 15, S6 is an attachment surface between the first quarter-wave plate 15 and the first polarizing reflective film 14 which are located on the image side of the second lens 12, S7 is the image-side surface of the first polarizing reflective film 14, S8 is the image-side surface of the second polarizing reflective film, S9 is an attachment surface between the second polarizing reflective film and the second quarter-wave plate 22, S10 is an attachment surface between the third lens 21 and the second quarter-wave plate 22, S11 is an attachment surface between the third lens 21 and the second transflective film 23, S12 is an eye-side surface of the third quarter-wave plate 33, S13 is an attachment surface between the third quarter-wave plate 33 and the linear polarizer 32, and S14 is an attachment surface between the screen body 31 and the linear polarizer 32.

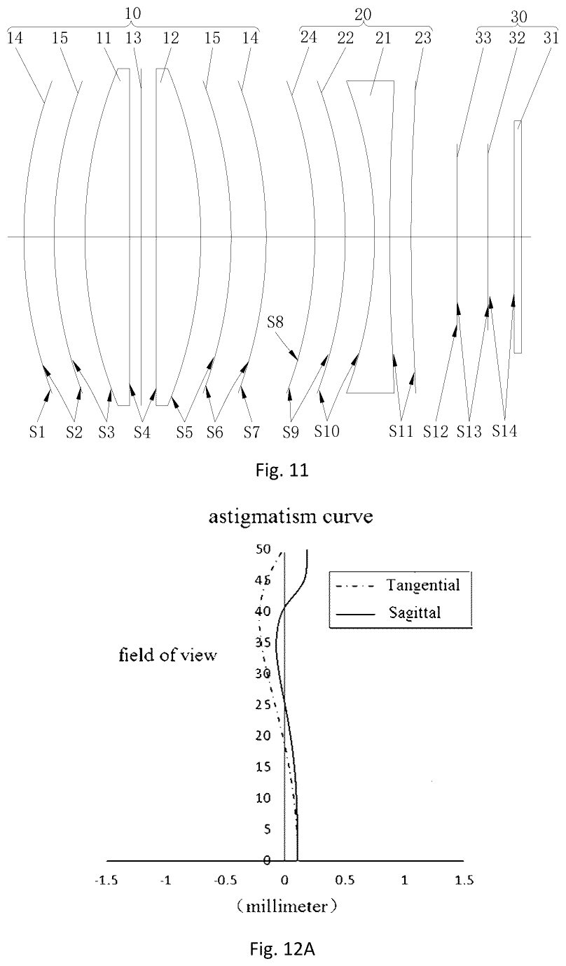

Referring to FIG. 8 and FIG. 11, the optical path and surface numbers are correspondingly explained as follows: regarding the optical path, reflection occurs on four surfaces, i.e. S2, S4, S9 and S11, and refraction occurs on two surfaces, i.e. S1, S3, S5, S6, S7, S8, S10, S12, S13 and S14. Specifically, light emitted from the screen body 31 passes through S14, S13, S12, S11 and S10 in sequence and is reflected by the second polarizing reflective film 24 located at S9 when reaching S9, then passes through S10 and is reflected by the second transflective film 23 located at S11 when reaching S11, and the light reflected by the second transflective film 23 passes through S10, S9, S8, S7, S6 and S5 in sequence and is divided into two parts by the first transflective film 13 located at S4 when reaching S4. A first part of light is the light refracted by the first transflective film 13, and the refracted light passes through S3 and is reflected by the first polarizing reflective film 14 located at S2 when reaching S2, the light reflected by the first polarizing reflective film 14 passes through S3 in sequence and is reflected by the first transflective film 13 located at S4 when reaching S4, and the light reflected by the first transflective film 13 passes through S3 and S2 sequentially and finally is emitted from S1 to reach human eyes. A second part of light is the light reflected by the first transflective film 13, the reflected light passes through S5 and is reflected by the first polarizing reflective film 14 located at S6 when reaching S6, and the light reflected by the first polarizing reflective film 14 passes through S4, S3 and S2 in sequence and finally is emitted from S1 to reach human eyes.

### Embodiment 3

As shown in FIGS. 7-9C, a VR eyepiece system according to Embodiment 3 is described, in the VR eyepiece system, the third lens 21 and the second lens 12 are arranged at an interval. Table 3 shows design data for the VR eyepiece system of Embodiment 3 in accordance with the conditional expressions above.

TABLE 3
Table of basic optical parameters of the VR eyepiece system of Embodiment 3

| | | | | | | | | | | | | Quadric |
|---|---|---|---|---|---|---|---|---|---|---|---|---|
| | Surface | Surface | | Curvature | | | | | | Refraction | Effective | surface |
| | number | type | | radius | | Thickness | | Materials | | mode | radius | constant K |
| STO | | Spherical | | Infinity | | 12.0000 | | | | Refraction | 2 | |
| | S1 | Quadric | RP | 121.2688 | | 0.1100 | | 1.49 | 57.5 | Refraction | 17.8894 | 3.06E+00 |
| | S2 | Quadric | QWP | 121.2688 | | 0.1100 | | 1.49 | 57.5 | Refraction | 17.9478 | 3.06E+00 |
| REFL1 | S3 | Aspheric | R1 | 121.2688 | CT1 | 3.3549 | N1 | 1.55 | 56.14 | Refraction | 18.0061 | 3.06E+00 |
| | | | | | | | V1 | | | | | |
| | S4 | Quadric | R2 | Infinity | | −3.3549 | | | | Refraction | 18.9219 | 3.06E+00 |
| | S3 | Quadric | R1 | 121.2688 | | −0.1100 | | 1.49 | 57.5 | Refraction | 18.0061 | 3.06E+00 |
| | S2 | Quadric | QWP | 121.2688 | | 0.1100 | | 1.49 | 57.5 | Refraction | 17.9478 | 3.06E+00 |
| | S3 | Aspheric | R1 | 121.2688 | | 3.3549 | | | | Refraction | 18.0061 | 3.06E+00 |
| REFL2 | S4 | Spherical | R2 | Infinity | CT2 | 3.3549 | N2 | 1.55 | 56.14 | Refraction | 18.9219 | |
| | | | | | | | V2 | | | | | |
| | S5 | Quadric | R4 | −121.2688 | | 0.1100 | | 1.49 | 57.5 | Refraction | 20.0712 | 3.06E+00 |
| | S6 | Quadric | QWP | −121.2688 | | 0.1100 | | 1.49 | 57.5 | Refraction | 20.0807 | 3.06E+00 |
| | S7 | Aspheric | RP | −121.2688 | | 10.0129 | | | | Refraction | 20.0902 | 3.06E+00 |
| | S8 | Aspheric | RP | −19.7729 | | 0.1100 | | 1.49 | 57.5 | Refraction | 20.1326 | −8.22E−01 |
| | S9 | Aspheric | QWP | −19.7729 | | 0.1100 | | 1.49 | 57.5 | Refraction | 20.1607 | −8.22E−01 |
| REFL3 | S10 | Aspheric | R5 | −19.7729 | CT3 | 4.9811 | N3 | 1.64 | 23.98 | Refraction | 20.1887 | −8.22E−01 |
| | | | | | | | V3 | | | | | |
| | S11 | Aspheric | R6 | −23.7245 | | −4.9811 | | | | Refraction | 22.1321 | −6.90E−01 |
| | S10 | Quadric | R5 | −19.7729 | | −0.1100 | | 1.49 | 57.5 | Refraction | 20.1887 | −8.22E−01 |
| | S9 | Quadric | QWP | −19.7729 | | 0.1100 | | 1.49 | 57.5 | Refraction | 20.1607 | −8.22E−01 |
| REFL3 | S10 | Aspheric | R5 | −19.7729 | CT3 | 4.9811 | N3 | 1.64 | 23.98 | Refraction | 20.1887 | −8.22E−01 |
| | | | | | | | V3 | | | | | |
| | S11 | Aspheric | R6 | −23.7245 | | 0.9310 | | | | Refraction | 22.1321 | −6.90E−01 |
| | S12 | Spherical | QWP | Infinity | | 0.1100 | | 1.49 | 57.5 | Refraction | 17.0723 | |

It is to be noted that, in the table above, STO indicates a diaphragm, REFL1 indicates the first lens 11, RELF2 indicates the second lens 12, RELF3 indicates the third lens 21, RP indicates a polarizing reflective film, QWP indicates a quarter-wave plate, and BS indicates a transflective film. In addition, in the VR eyepiece system shown in Embodiment 3, TTL=23.55 mm, ED=12.00 mm, Imgh=17.01 mm, HFOV=50.00°, FNO=5.29 mm, f=21.19 mm, f1=−3558.20 mm, f2=3436.93 mm, f3=49.47 mm, E1=1.62 mm, E2=1.62 mm, and E3=4.68 mm.

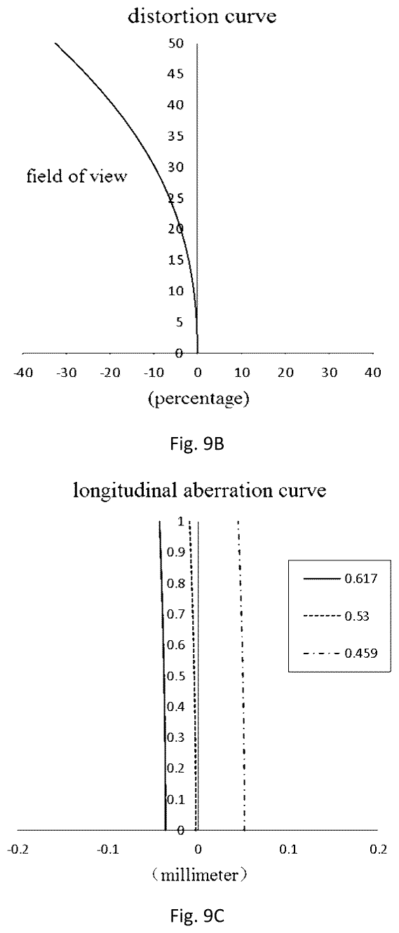

Upon simulation test, it is obtained that an astigmatism curve of the VR eyepiece system of Embodiment 3 is as shown in FIG. 9A, a distortion curve of the VR eyepiece system of Embodiment 3 is as shown in FIG. 9B, and a longitudinal aberration curve of the VR eyepiece system of Embodiment 3 is as shown in FIG. 9C. From FIG. 9A to FIG. 9C, it is determined that the VR eyepiece system of Embodiment 3 is able to achieve good imaging quality.

### Embodiment 4

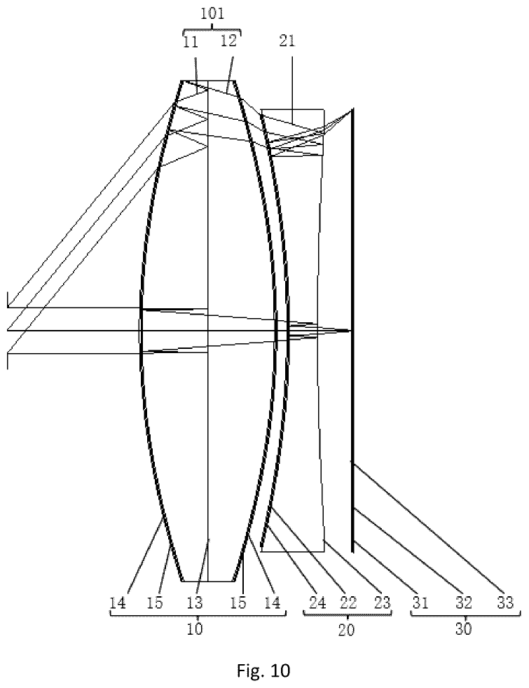

As shown in FIGS. 10-12C, a VR eyepiece system according to Embodiment 4 is described, in the VR eyepiece system, the third lens 21 and the second lens 12 are arranged at an interval. Table 4 shows design data for the VR eyepiece system of Embodiment 4 in accordance with the conditional expressions above.

TABLE 4
Table of basic optical parameters of the VR eyepiece system of Embodiment 4

| | | | | | | | | | | | | Quadric |
|---|---|---|---|---|---|---|---|---|---|---|---|---|
| | Surface | Surface | | Curvature | | | | | | Refraction | Effective | surface |
| | number | type | | radius | | Thickness | | Materials | | mode | radius | constant K |
| STO | | Spherical | | Infinity | | 12.0000 | | | | Refraction | 2 | |
| | S1 | Quadric | RP | 59.7167 | | 0.1100 | | 1.49 | 57.5 | Refraction | 20.0629 | −3.30E+00 |
| | S2 | Quadric | QWP | 59.7167 | | 0.1100 | | 1.49 | 57.5 | Refraction | 20.1112 | −3.30E+00 |
| REFL1 | S3 | Aspheric | R1 | 59.7167 | CT1 | 6.0055 | N1 | 1.55 | 56.14 | Refraction | 20.1596 | −3.30E+00 |
| | | | | | | | V1 | | | | | |
| | S4 | Quadric | R2 | Infinity | | −6.0055 | | | | Reflection | 21.1631 | −3.30E+00 |
| | S3 | Quadric | R1 | 59.7167 | | −0.1100 | | 1.49 | 57.5 | Refraction | 20.1596 | −3.30E+00 |
| | S2 | Quadric | QWP | 59.7167 | | 0.1100 | | 1.49 | 57.5 | Reflection | 20.1112 | −3.30E+00 |
| | S3 | Aspheric | R1 | 59.7167 | | 6.0055 | | | | Refraction | 20.1596 | −3.30E+00 |
| REFL2 | S4 | Spherical | R2 | Infinity | CT2 | 6.0055 | N2 | 1.55 | 56.14 | Refraction | 21.1631 | |
| | | | | | | | V2 | | | | | |
| | S5 | Quadric | R4 | −59.7167 | | 0.1100 | | 1.49 | 57.5 | Refraction | 20.5685 | −3.30E+00 |
| | S6 | Quadric | QWP | −59.7167 | | 0.1100 | | 1.49 | 57.5 | Refraction | 20.5307 | −3.30E+00 |
| | S7 | Aspheric | RP | −59.7167 | | 0.9081 | | | | Refraction | 20.4929 | −3.30E+00 |
| | S8 | Aspheric | RP | −69.4938 | | 0.1100 | | 1.49 | 57.5 | Refraction | 18.9892 | −4.72E+00 |
| | S9 | Aspheric | QWP | −69.4938 | | 0.1100 | | 1.49 | 57.5 | Refraction | 18.9476 | −4.72E+00 |
| REFL3 | S10 | Aspheric | R5 | −69.4938 | CT3 | 2.5675 | N3 | 1.64 | 23.98 | Refraction | 18.9061 | −4.72E+00 |
| | | | | | | | V3 | | | | | |
| | S11 | Aspheric | R6 | 250 | | −2.5675 | | | | Reflection | 17.3373 | −7.49E+01 |
| | S10 | Quadric | R5 | 69.4938 | | −0.1100 | | 1.49 | 57.5 | Refraction | 18.9061 | −4.72E+00 |
| | S9 | Quadric | QWP | −69.4938 | | 0.1100 | | 1.49 | 57.5 | Reflection | 18.9476 | −4.72E+00 |
| REFL3 | S10 | Aspheric | R5 | −69.4938 | CT3 | 2.5675 | N3 | 1.64 | 23.98 | Refraction | 18.9061 | −4.72E+00 |
| | | | | | | | V3 | | | | | |
| | S11 | Aspheric | R6 | 250 | | 3.0337 | | | | Refraction | 17.3373 | −7.49E+01 |
| | S12 | Spherical | QWP | Infinity | | 0.1100 | | 1.49 | 57.5 | Refraction | 19.3411 | |

It is to be noted that, in the table above, STO indicates a diaphragm, REFL1 indicates the first lens 11, RELF2 indicates the second lens 12, RELF3 indicates the third lens 21, RP indicates a polarizing reflective film, QWP indicates a quarter-wave plate, and BS indicates a transflective film. In addition, in the VR eyepiece system shown in Embodiment 4, TTL=19.44 mm, ED=12.00 mm, Imgh=19.43 mm, HFOV=50.00°, FNO=5.79 mm, f=23.62 mm, f1=−1752.17 mm, f2=1692.46 mm, f3=−211.29 mm, E1=2.20 mm, E2=2.20 mm, and E3=5.74 mm.

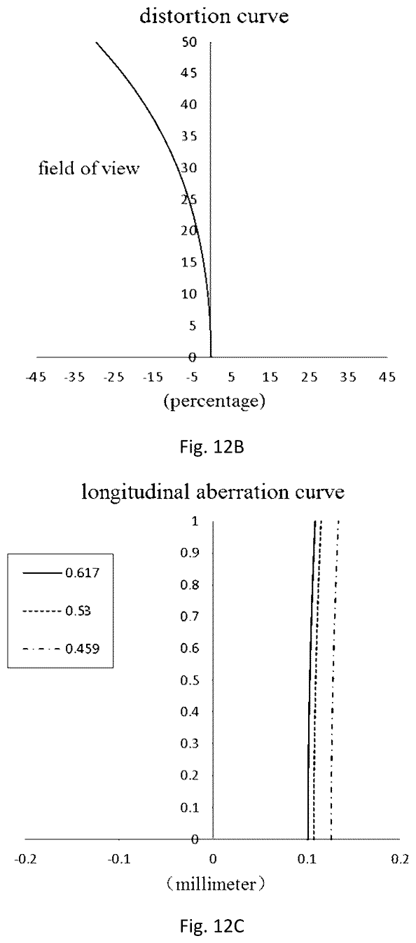

Upon simulation test, it is obtained that an astigmatism curve of the VR eyepiece system of Embodiment 4 is as shown in FIG. 12A, a distortion curve of the VR eyepiece system of Embodiment 4 is as shown in FIG. 12B, and a longitudinal aberration curve of the VR eyepiece system of Embodiment 4 is as shown in FIG. 12C. From FIG. 12A to FIG. 12C, it is determined that the VR eyepiece system of Embodiment 4 is able to achieve good imaging quality.

In summary, the optical parameters in the VR eyepiece systems in Embodiment 1 to Embodiment 4 are as shown in Table 5:

TABLE 5
Table of optical parameters of the VR eyepiece systems
as shown in Embodiment 1 to Embodiment 4

| Parameters in | | | | |
|---|---|---|---|---|
| Embodiments | 1 | 2 | 3 | 4 |
| TTL | 16.65 | 18.60 | 23.55 | 19.44 |
| ED | 12.00 | 12.00 | 12.00 | 12.00 |
| Imgh | 12.22 | 17.33 | 17.01 | 19.43 |
| HFOV | 50.00 | 50.00 | 50.00 | 50.00 |
| FNO | 4.10 | 5.56 | 5.29 | 5.79 |
| f | 16.43 | 22.58 | 21.19 | 23.62 |
| f1 | −1626.41 | −1661.65 | −3558.20 | −1752.17 |
| f2 | 1570.98 | 1605.02 | 3436.93 | 1692.46 |
| f3 | −51.61 | 623.67 | 49.47 | −211.29 |
| E1 | 1.58 | 1.72 | 1.62 | 2.20 |
| E2 | 1.58 | 1.72 | 1.62 | 2.20 |
| E3 | 4.36 | 6.07 | 4.68 | 5.74 |

The relationships among the parameters satisfy the relationships as shown in Table 6, which are specifically as shown in Table 6:

TABLE 6
Table of conditional expressions satisfied
by the VR eyepiece systems

| Combination of conditional | Embodiments | | | |
|---|---|---|---|---|
| expressions | 1 | 2 | 3 | 4 |
| R4/R5 | 1.00 | 1.00 | 6.13 | 0.86 |
| f*tan (HFOV)/Imgh | 1.60 | 1.55 | 1.48 | 1.45 |
| \|Dist0.8\| | 23.65% | 20.57% | 19.30% | 16.90% |
| f/TTL | 0.99 | 1.21 | 0.90 | 1.21 |
| (CT1 + CT2 + T23)/TTL | 0.74 | 0.66 | 0.73 | 0.69 |
| (CT1 + CT2)/CT3 | 4.16 | 4.95 | 1.35 | 4.68 |
| ET3/(ET1 + ET2) | 1.38 | 1.76 | 1.44 | 1.30 |
| EPD/Imgh | 0.33 | 0.23 | 0.24 | 0.21 |
| ED/TTL | 0.72 | 0.65 | 0.51 | 0.62 |

Various technical features of the embodiments above can be combined in any way, and in order to make the description brief, all possible combinations of the technical features of the embodiments are not described. However, as long as the combination of these technical features is not contradictory, the technical features should be considered to fall within the scope disclosed in the description.

The embodiments as described above merely represent several embodiments of the disclosure, and the illustration thereof is specific and detailed, but the specific and detailed illustration cannot be understood as limiting the patent scope of the disclosure. It should be noted that for a person of ordinary skill in the art, several modifications and improvements can be made without departing from the concept of the disclosure, and all these modifications and improvements fall within the scope of protection of the disclosure. Therefore, the patent scope of protection of the disclosure shall be subject to the appended claims.

1. An optical module, sequentially comprising along an optical axis from an eye side to an image side:
a cemented lens group, comprising a pair of plano-convex lenses which are symmetrically arranged and have mutually cemented flat surfaces, a first transflective film located between the pair of plano-convex lenses, a pair of first quarter-wave plates respectively arranged outside of the pair of plano-convex lenses, and a pair of first polarizing reflective films respectively arranged outside of the pair of first quarter-wave plates; and
a refraction and reflection assembly, comprising a third lens, and a second quarter-wave plate arranged at an eye-side surface of the third lens and a second transflective film arranged at an image-side surface of the third lens.

2. The optical module according to claim 1, wherein the pair of plano-convex lenses are respectively a first lens away from the third lens and having a negative refractive power and a second lens close to the third lens and having a positive refractive power, and an eye-side surface of the third lens is a concave surface.

3. The optical module according to claim 2, wherein the eye-side surface of the third lens is cemented to an image-side surface of the second lens.

4. The optical module according to claim 2, wherein the third lens and the second lens are arranged at an interval, and a second polarizing reflective film is further provided on an eye-side surface of the refraction and reflection assembly.

5. The optical module according to claim 4, wherein a thickness of each of the pair of first polarizing reflective films and a thickness of the second polarizing reflective film are greater than or equal to 0.1 mm and less than or equal to 0.12 mm;
a thickness of each of the pair of first quarter-wave plates and a thickness of the second quarter-wave plate are greater than or equal to 0.1 mm and less than or equal to 0.12 mm; and/or
a thickness of the first transflective film and a thickness of the second transflective film are greater than or equal to 0.1 mm and less than or equal to 0.12 mm.

6. The optical module according to claim 4, wherein an included angle between a slow axis of one of the pair of first quarter-wave plates and a polarization axis of one of the pair of first polarizing reflective films which are adjacent is 45°, and an included angle between a slow axis of the second quarter-wave plate and a polarization axis of the second polarizing reflective film which are adjacent is 45°.

7. The optical module according to claim 2, wherein a curvature radius R1 of an eye-side surface of the first lens, a curvature radius R4 of an image-side surface of the second lens, and a curvature radius R5 of the eye-side surface of the third lens satisfy: R1=R4; and 0.84<R4/R5<6.15.

8. The optical module according to claim 2, wherein a center thickness CT1 of the first lens, a center thickness CT2 of the second lens, and a center thickness CT3 of the third lens satisfy:
$$1.33 < ( CT 1 + CT 2 ) / CT 3 < 4.97 .$$

9. The optical module according to claim 2, wherein an edge thickness ET1 of the first lens, an edge thickness ET2 of the second lens and an edge thickness ET3 of the third lens satisfy:
$$1.28 < ET 3 / ( ET 1 + ET 2 ) < 1.78 .$$

10. A VR eyepiece system, comprising:
the optical module according to claim 1; and
a display screen arranged on an image-side surface of the optical module, wherein the display screen comprises a screen body, and a linear polarizer and a third quarter-wave plate which are sequentially arranged on an eye-side surface of the screen body from an image side to an eye side, an included angle between a slow axis of the third quarter-wave plate and a polarization axis of the linear polarizer is 45°.

11. The VR eyepiece system according to claim 10, wherein Imgh is a half of a diagonal length of an effective pixel region of the screen body, and an effective focal length f of the optical module, a half field of view HFOV of the optical module and the Imgh satisfy:
$$1.43 < f * tan ( HFOV / Imgh < 1.62 .$$

12. The VR eyepiece system according to claim 10, wherein a distortion |Dist0.8| of 0.8 field of view of the VR eyepiece system satisfies: 16.50%<|Dist0.8|<23.67%.

13. The VR eyepiece system according to claim 10, wherein an effective focal length f of the optical module and a distance TTL between an eye-side surface of the cemented lens group of the optical module and the display screen on the optical axis satisfy: 0.88<f/TTL<1.23.

14. The VR eyepiece system according to claim 10, wherein a center thickness CT1+CT2 of the cemented lens group of the optical module, a distance T23 from an image-side surface of the cemented lens group of the optical module to the eye-side surface of the third lens of the optical module on the optical axis, and a distance TTL from an eye-side surface of the cemented lens group of the optical module to the display screen on the optical axis satisfy:
$$0.64 < ( CT 1 + CT 2 + T 23 ) / TTL < 0.76 .$$

15. The VR eyepiece system according to claim 10, wherein the VR eyepiece system has an entrance pupil diameter EPD, and Imgh is a half of a diagonal length of an effective pixel region of the screen body, and the entrance pupil diameter EPD and the Imgh satisfy:
$$0.2 < EPD / Imgh < 0.35 .$$

16. The VR eyepiece system according to claim 10, wherein the VR eyepiece system has an eye position, and a distance ED from the eye position to an eye-side surface of the cemented lens group of the optical module on the optical axis and a distance TTL from an eye-side surface of the cemented lens group of the optical module to the display screen on the optical axis satisfy:
$$0.5 < ED / TTL < 0.74 .$$
